(19) United States
(12) Patent Application Publication
(10) Pub. No.: US 2022/0306053 A1
(43) Pub. Date: Sep. 29, 2022

(54) BRAKE DEVICE FOR A VEHICLE, VEHICLE COMPRISING THE BRAKE DEVICE, AND METHOD FOR BRAKING A ROTATING WHEEL OF A VEHICLE COMPRISING THE BRAKE DEVICE

(71) Applicant: Schaeffler Technologies AG & Co. KG, Herzogenaurach (DE)

(72) Inventors: Stephane Rocquet, Sandillon (FR); Julien Durr, Fleury les aubrais (FR); Alexis Galant, Saran (FR); Simon Ortmann, Baden-Baden (DE)

(73) Assignee: Schaeffler Technologies AG & Co. KG, Herzogenaurach (DE)

(21) Appl. No.: 17/618,039

(22) PCT Filed: May 14, 2020
(86) PCT No.: PCT/DE2020/100416

§ 371 Date: Dec. 10, 2021

(30) Foreign Application Priority Data
Jun. 18, 2019 (DE) 10 2019 116 427.3

(51) Int. Cl. B60T 1/06; B62K 3/00; B62L 3/02; B62L 1/10

(52) U.S. Cl. CPC B60T 1/065; B62K 3/002; B62L 3/023; B62L 1/10; B62K 2204/00

(57) ABSTRACT

A brake device for a vehicle comprising at least one wheel, in particular for an electric motorcycle or electric scooter, said device comprising a housing for positioning on a wheel axle of the vehicle. The vehicle has a brake disc for introducing braking power into a wheel rim of the wheel and transfer apparatus for transferring the braking power to the brake disc. The transfer apparatus is held in the housing and is operatively connected to the brake disc, said brake disc being formed integrally with the housing.

### CROSS-REFERENCE TO RELATED APPLICATIONS

This application is the U.S. National Phase of PCT Appln. No. PCT/DE2020/100416 filed May 14, 2020, which claims priority to DE 102019116427.3 filed Jun. 18, 2019, the entire disclosures of which are incorporated by reference herein.

### TECHNICAL FIELD

The disclosure relates to a brake device for a vehicle comprising at least one wheel, in particular for an electric motorcycle or electric scooter. The brake device comprises a housing for positioning on a wheel axle of the vehicle, a brake disc for introducing braking power into a wheel rim of the wheel and a transfer apparatus for transferring the braking power to the brake disc, wherein the transfer apparatus is held in the housing. The disclosure further relates to a vehicle having at least one wheel and having the brake device and a method for braking a rotating wheel of a vehicle having the brake device.

### BACKGROUND

Disc brakes are often used on two-wheeled vehicles such as pedal scooters or scooters or even on bicycles, in order to brake the vehicle safely.

For example, the publication DE 200 16 878 U1 describes a pedal scooter with a brake device which is designed as a hydraulically activated disc brake. The brake device has a brake caliper which is fastened to the vehicle frame, engages around the brake disc and is pressed against the brake disc when actuated.

### SUMMARY

The disclosure is based on the object of providing a brake device that saves installation space and is adapted to a wheel size of a wheel of a vehicle. This object is achieved by a brake device for a vehicle having at least one wheel as described herein, by a vehicle having at least one wheel and having the brake device according to the disclosure and by a method for braking a rotating wheel of a vehicle having the brake device according to the disclosure. Preferred or advantageous embodiments of the disclosure are disclosed in the following description and/or the attached figures.

A brake device for a vehicle having at least one wheel, which is preferably a front wheel, is proposed. The vehicle is preferably designed as a small or micro vehicle or as an electric vehicle. The vehicle preferably has at least one wheel. With only one wheel, the vehicle can be designed as an electric unicycle, for example as a so-called monowheel or solowheel. With two or more wheels, the vehicle is preferably designed as a scooter, in particular an electric motorcycle, an electric motor scooter, an electric scooter, electric pedal scooter, e-scooter, a segway, hoverboard, kickboard, skateboard, longboard or the like. Alternatively, the vehicle can be designed as a bicycle, in particular as an electric bicycle, for example as a pedelec or an e-bike. The vehicle can alternatively be designed as a multi-track bicycle, in particular having three or more wheels. For example, the vehicle can be a transport or cargo bike, in particular a motorized or electrically driven transport or cargo bike, in particular a three-wheeled or four-wheeled pedelec or a rickshaw, in particular with or without a roof, or a cabin scooter.

The brake device has a housing. For example, in a lateral plan view, in particular in a plan view of a visible side of the housing, the housing is designed to be annular in shape. In particular, the housing has a central recess. The housing is designed to be arranged on a wheel axle of a vehicle. A wheel having a wheel rim is preferably rotatably mounted on the wheel axle.

To arrange the housing on the wheel axle, it can extend through the central recess in the annular housing. The housing is preferably formed from a plastic material. This has the advantage that the housing can be manufactured inexpensively and has a low weight. Alternatively, the housing can be formed from an aluminum alloy.

In an optional embodiment of the disclosure, the brake device comprises an axle sleeve. The axle sleeve is preferably arranged in the central recess of the annular housing. For example, the axle sleeve is formed from a metal alloy, in particular from a steel alloy. It is possible within the scope of the disclosure for the axle sleeve to be integrated in the central recess in a form-fitting and/or force-fitting manner. Alternatively, it is possible for the axle sleeve to be integrated in the housing in a materially bonded manner, for example by inserting and/or reshaping the axle sleeve with the plastic material from which the housing is formed. The axle sleeve preferably has an inner diameter which is adapted to an outer diameter of the wheel axle, so that the housing can be arranged on the wheel axle via the axle sleeve, for example in a force-fitting manner. Alternatively, the axle sleeve can also be connected to the wheel axle in a form-fitting or materially bonded manner in order to fasten the housing on the wheel axle. Because it is fastened via the axle sleeve, the housing can advantageously be centered on the wheel axle.

Optionally in addition, the axle sleeve also has a torque support. In particular, the torque support is arranged on the axle sleeve and is intended to be supported on a wheel fork of the vehicle. The wheel fork preferably carries the wheel axle and the wheel rotatably mounted thereon. In particular, the torque support is designed to absorb a differential torque from the input and output of the wheel and to introduce this into the wheel fork.

The brake device has a brake disc which is designed to introduce braking power into a wheel rim of the wheel. The brake disc is preferably arranged on the wheel axle and is axially movable thereon. In particular, the brake disc can be moved linearly and/or axially towards the wheel rim and can be placed against it and/or pressed onto it in order to brake the rotating wheel by friction. The brake device is preferably a friction brake.

The brake device comprises a transfer apparatus. The transfer apparatus is held in the housing, preferably completely. The transfer apparatus and the brake disc preferably span planes which are aligned and/or parallel to one another. The transfer apparatus is designed to transfer the braking power to the brake disc. In particular, the transfer apparatus is designed to activate the brake disc to brake the rotating wheel.

To transfer the braking power, the transfer apparatus is operatively connected to the brake disc. The transfer apparatus is preferably fastened to the brake disc, for example it can be screwed to it. In particular, the transfer apparatus is axially movable together with the brake disc. In particular, the transfer apparatus transfers the braking power in the form of kinetic energy to the brake disc by moving the brake disc axially towards the wheel and thereby activating it. In particular, the activated brake disc is applied and/or pressed onto the wheel rim at least in sections in order to brake the rotating wheel.

According to the disclosure, the brake disc is formed integrally with the housing.

In particular, the brake disc is integrated in one piece and/or in one material in the housing and/or the brake disc forms the housing at least in sections. For example, the brake disc has an annular surface and a circumferential edge protruding axially from the annular surface. In particular, the edge encloses a receiving space with the annular surface, which in particular forms at least part of a receiving space of the housing. For example, the brake disc has a shape that is essentially the same as the shape of a frisbee disc.

It is particularly preferred that the brake disc forms a visible side of the housing or that the visible side of the housing is part of the brake disc. In particular, the rear side of the disc surface forms the visible side of the housing so that this is the only visible part of the brake device when it is arranged next to the wheel on the wheel axle.

It is advantageous that the one-piece and/or materially bonded integration of the brake disc into the housing can reduce the number of components and thereby support a design of the brake device that saves space. Another advantage is that the visible side of the housing, which preferably corresponds to the rear of the brake disc, can be designed flexibly. In particular, a desired design and an attractive appearance can be implemented in the manufacture of the housing, for example in a forming or injection molding process.

It is also advantageous that the arrangement of the transfer apparatus in the housing, in particular in the receiving space of the brake disc, and the integration of the brake disc in the housing, can provide a space-saving brake device. The brake device can thereby preferably be adapted to the size of the wheel, in particular to the size of the wheel rim. Because the transfer apparatus is held in the housing, it does not build up towards the outside, as is the case, for example, with conventional brake pads of a disc brake.

In a preferred constructive implementation of the disclosure, the transfer apparatus is designed as a disc, in particular as a metal disc. The transfer apparatus is preferably arranged concentrically to the brake disc. For example, as a disc, the transfer apparatus has a smaller diameter than the brake disc so that the brake disc, in particular as part of the housing, can hold the transfer apparatus. It is particularly preferred that the transfer apparatus is arranged in the receiving space of the brake disc. Optionally, the transfer apparatus can be held in an axially movable manner.

In a possible development of the disclosure, the brake device comprises a hydraulic device. The hydraulic device is preferably designed to generate braking power, in particular in the form of kinetic energy. For example, the hydraulic device comprises a reciprocating piston and a hydraulic chamber. It is preferred that the hydraulic device, in particular the hydraulic chamber and the reciprocating piston, are arranged and/or integrated in the housing, in particular in the brake disc as part of the housing. It is particularly preferred that the hydraulic chamber is molded into the housing. In particular, the hydraulic device is arranged between the rear of the housing and the transfer apparatus.

For example, the hydraulic chamber is designed to be annular in a lateral plan view. The hydraulic chamber is preferably integrated concentrically to the brake disc and/or to the transfer apparatus. The reciprocating piston is particularly preferably designed as an annular piston. In particular, the reciprocating piston is axially movable in the hydraulic chamber when a fluid is introduced into the hydraulic chamber. The reciprocating piston can perform an axial stroke and a return stroke, in which case it presses against the transfer apparatus during the stroke. As a result, the braking power, in particular as kinetic energy, is transferred to the transfer apparatus. In particular, the transfer apparatus is axially displaced by the stroke of the reciprocating piston.

In a preferred embodiment of the disclosure, the transfer apparatus transfers the braking power to the brake disc which is operatively connected to the transfer apparatus. In particular, the brake disc is axially displaceable together with the transfer apparatus and can thereby be placed against and/or pressed against the wheel rim, in particular with the edge of the brake disc, in order to brake the rotating wheel. In summary, the kinetic energy of the reciprocating piston can be transferred as braking power to the transfer apparatus and from there to the brake disc.

In a preferred constructive embodiment of the disclosure, the brake device comprises at least one leaf spring. Optionally, the at least one leaf spring is fixed on the axle sleeve, for example riveted thereto. The at least one leaf spring is preferably designed to release the activated brake disc, in particular from the wheel rim. The at least one leaf spring preferably presses the brake disc back into its initial position before activation, so that it is arranged without contact with the wheel rim. For this purpose, the brake disc is preferably mounted elastically on the at least one leaf spring. In particular, the brake disc can be pushed back by the at least one leaf spring when the actuating device is no longer actuated and the reciprocating piston thereby executes a return stroke in the hydraulic system. This has the consequence that the transfer apparatus is no longer displaced axially along the wheel axle and that the brake disc is no longer pressed against the wheel rim.

In one possible implementation of the disclosure, the brake device comprises a plurality of leaf springs, for example three leaf springs, which are arranged in a ring around the central recess and/or around the axle sleeve in the housing. The leaf springs preferably complement one another to form a spring ring, which is interrupted a plurality of times, for example. In particular, the leaf springs form ring sections of the spring ring. In particular, the leaf springs and/or the spring ring are held in the housing concentrically with the brake disc and/or with the transfer apparatus. Due to the annular arrangement of the leaf springs, the brake disc can be pushed back to the initial position evenly centered, e.g., in the manner of a clutch pressure plate. It is advantageous that the torque support is not loaded and worn due to this arrangement and/or design of the leaf springs.

In a possible development of the disclosure, the brake device comprises a friction plate. The friction plate is preferably designed as a friction ring. For example, the friction plate is formed from a steel alloy. In particular, the friction plate is arranged concentrically with the brake disc and/or with the transfer apparatus in the housing. The friction plate is preferably placed on the brake disc. In particular, the friction plate is arranged on the edge of the brake disc and/or placed on the edge. As a result, the friction plate forms a contact side of the brake disc with which it can contact the wheel rim for braking. The friction plate is preferably connected to the brake disc, in particular to the edge of the brake disc, for example by flanging, crimping, riveting or screwing.

In the event that the friction plate is provided, the brake disc and/or the housing is/are preferably formed from the aluminum alloy. The edge of the activated brake disc can preferably rest against the wheel rim and/or be pressed against it in order to brake the rotating wheel by means of friction. By arranging the friction plate on the brake disc, wear of the brake disc when it is placed on and/or pressed against the rotating wheel rim can be reduced as far as possible.

Another subject matter of the disclosure is a vehicle having at least one wheel, preferably having two or more wheels, having the brake device according to the description above and/or according to one of the claims. The vehicle is preferably designed as a two-wheeled vehicle, for example an electric scooter, an e-scooter or an electric bicycle.

In a preferred embodiment, the vehicle comprises at least one wheel, preferably two wheels, wherein the at least one wheel has a wheel rim. Optionally in addition, the wheel comprises a wheel axle, wherein the wheel is rotatably mounted on the wheel axle. The vehicle preferably comprises a vehicle frame with a wheel fork. The wheel fork preferably carries the wheel axle with the wheel rotatably mounted thereon. It is possible within the scope of the disclosure that an electric motor is provided to drive the wheel. The electric motor can be designed as a wheel hub motor, for example.

In a further preferred embodiment of the disclosure, the brake device is arranged adjacent to the wheel and/or on one side of the wheel on the wheel axle. For example, the brake device with the axle sleeve is arranged on the wheel axle in an interference fit. As an alternative to this form-fitting connection, the axle sleeve can also be connected to the wheel axle in a form-fitting or materially bonded manner in order to fasten the brake device thereto.

It is particularly preferred within the scope of the disclosure that the activated brake disc, optionally together with the friction plate, can be moved linearly, in particular axially, towards the wheel rim and placed against it and/or pressed onto it in order to brake the rotating wheel. The braking effect occurs by means of friction between the brake disc or the friction plate placed on the brake disc and the wheel rim.

Another subject matter of the disclosure is a method for braking a rotating wheel of a vehicle having the brake device according to the description above and/or according to one of the claims. As part of the method, the transfer apparatus is moved axially towards the wheel of the vehicle together with the brake disc so that the brake disc is placed against the wheel rim of the wheel and/or so that the brake disc is pressed onto the wheel rim and the rotating wheel is thereby braked. The transfer apparatus is preferably axially displaced and/or set into axial movement by a stroke of the reciprocating piston. In particular, the brake disc placed on the wheel rim and/or pressed onto it is released again by the at least one leaf spring, whereby the braking of the rotating wheel is ended.

### BRIEF DESCRIPTION OF THE DRAWINGS

Further features, advantages and effects of the disclosure are set out in the following description of the preferred embodiments of the disclosure. In the figures:

FIG. 1 shows a vehicle with two wheels, wherein the vehicle is designed as an electric scooter;

FIG. 2 shows one of the wheels from FIG. 1;

FIG. 3 shows a plan view of a visible side of a brake device for the wheel from FIG. 2;

FIG. 4 shows an axial sectional view of the brake device from FIG. 3;

FIG. 5 shows a perspective plan view of a rear side of the brake device from FIG. 3.

### DETAILED DESCRIPTION

Parts that correspond to each other or are identical are marked with the same reference marks in the illustrations.

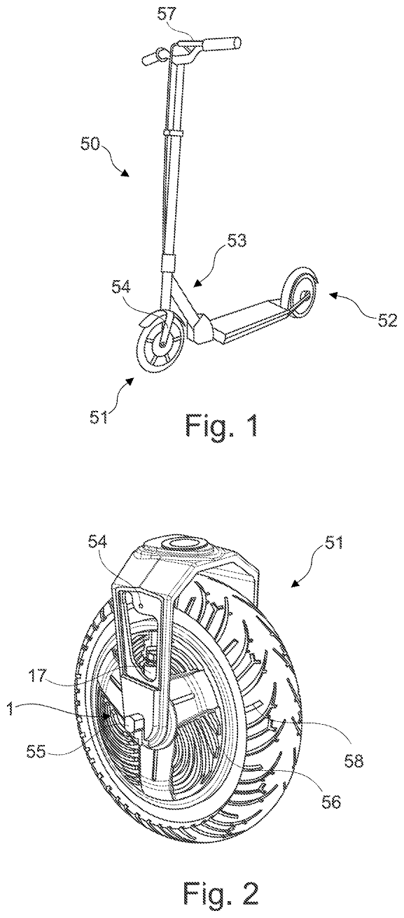

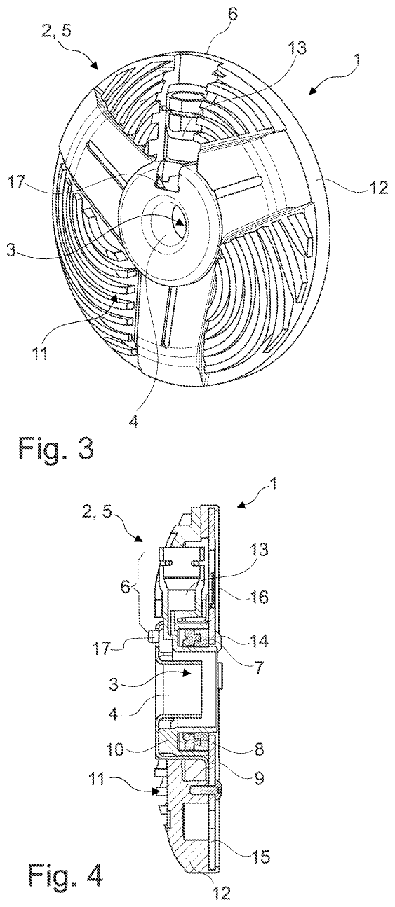

FIG. 1 shows a vehicle 50 having a front wheel 51 and a rear wheel 52. The vehicle 50 is designed as an electric scooter, electric pedal scooter or e-scooter. It has a vehicle frame 53 having a wheel fork 54. The vehicle 50 can be driven by an electric motor which is integrated in the wheel, for example. To brake the front wheel 51, the vehicle 50 has a brake device 1, which is shown in FIGS. 3 to 5.

The front wheel 51 of the vehicle 50 is shown in FIG. 2 in a perspective plan view from the side. The front wheel 51 is hereinafter referred to as the wheel 51. The wheel 51 is rotatably mounted on a wheel axle 55. The wheel fork 54 carries the wheel axle 55 and thus the wheel 51. The wheel fork 54 is rotatably mounted and, according to FIG. 1, is connected to a handlebar of the vehicle 50 so that the vehicle 50 can be steered via the wheel 51.

The wheel 51 has a wheel rim 56 and a tire 58, wherein the tire 58 is arranged on the wheel rim 56. The wheel rim is not visible in FIG. 2 because it is covered by the tire 58. The brake device 1 is arranged on the wheel axle 55 adjacent to the wheel rim 56 and/or on one side of the wheel rim 56.

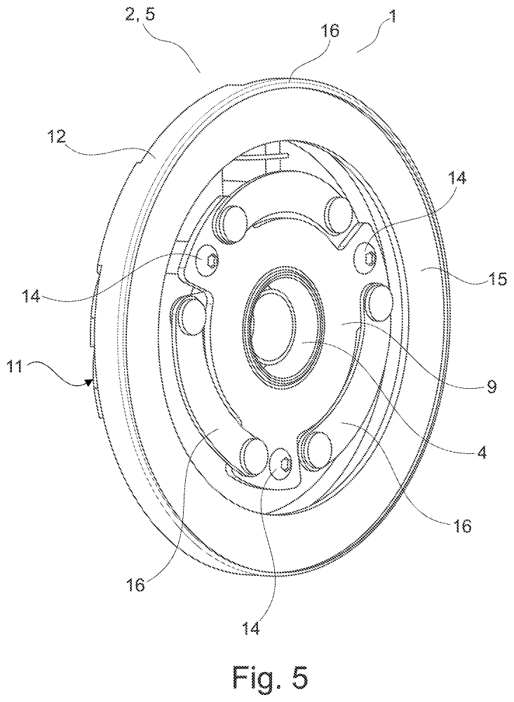

In FIG. 3, the brake device 1 is shown in a perspective plan view of a visible side and, in FIG. 5, of a rear side of the brake device 1. An axial sectional view of the brake device 1 is shown in FIG. 4.

As shown in FIGS. 3 to 5, the brake device 1 comprises a housing 2, which is arranged on the wheel axle 55, according to FIG. 2. The housing 2 can be designed as a plastic housing or as an aluminum housing. It is essentially disc-shaped and has a central recess 3 for the wheel axle 55.

For the arrangement on the wheel axle 55, the brake device 1 has an axle sleeve 4. The axle sleeve 4 is formed from a metal alloy, for example from a steel alloy. The axle sleeve 4 is arranged in the central recess 3. It has an inner diameter that essentially corresponds to an outer diameter of the wheel axle 55. In particular, the brake device 1 is fixed in a press fit on the wheel axle 55 via the axle sleeve 4, as shown in FIG. 2.

According to FIGS. 4 and 5, the brake device 1 comprises a brake disc 5 and a transfer apparatus 9. The brake disc 5 is designed to introduce braking power into the wheel rim of the wheel 51 and thereby to brake the rotating wheel 51. The transfer apparatus 9 is designed to transfer the braking power to the brake disc 5.

To generate the braking power, the brake device 1 has a hydraulic device 6. The hydraulic device 6 can be actuated by an actuating device 57 (FIG. 1), for example a hand lever of the vehicle. The hydraulic device 6 comprises a hydraulic chamber 7 and a reciprocating piston 8, which can perform a stroke and a return stroke in the hydraulic chamber 7. The reciprocating piston 8 is sealed off from the hydraulic chamber 7 via a sealing valve 10. When actuating the actuating device 57 (FIG. 1), the sealing valve 10 is opened so that a fluid can flow through a flow channel 13 of the hydraulic device 6 into the hydraulic chamber 7 and trigger the stroke of the reciprocating piston 8. The stroke of the reciprocating piston 8 releases kinematic energy which is used by the brake disc 5 as braking power.

The brake disc 5 is formed integrally with the housing 2. For this purpose, the brake disc 5 is designed in the manner of a frisbee disc. As can be seen from FIG. 3, it has a disc surface 11 and a circumferential edge 12, wherein the circumferential edge 12 protrudes axially from the disc surface 11 and, together with the disc surface 11, encloses a receiving space. The receiving space of the brake disc 5 at least partially forms a section of the receiving space of the housing 2. The receiving space is open on the wheel axle 55 (FIG. 2) towards the wheel rim 56, whereas an outside of the disc surface 11 is arranged facing away from the wheel rim 56 and forms a visible side of the housing 2 and thus the brake device 1. The brake disc 5 is axially movable towards the wheel rim 56 along the wheel axle 55 (FIG. 2).

It is advantageous that the outside of the disc surface 11, in particular the visible side of the housing 2 and the brake device 1, can be designed in a visually flexible manner since the housing 2, in particular the brake disc 5, is formed from the plastic material or the aluminum alloy. A desired design of the housing 2, in particular the visible side, can thus be implemented in a simple and inexpensive manner, for example in a forming process or injection molding process. In the exemplary embodiment in FIG. 3, the visible side has decorative ribs.

It is also advantageous that the size of the brake device 1 can be adapted to the size of the wheel 51 in that the housing 2 and/or the brake disc 5 integrated in the housing 2 together with the wheel 51 is arranged on the wheel axle 55 (FIG. 2).

The hydraulic device 6 (FIG. 4) is held and/or integrated in the housing 2. In particular, the hydraulic chamber 7 and the flow channel 13 are molded into the housing 2. The hydraulic chamber 7 is annular in a lateral plan view and runs around the central recess 3 and/or the axle sleeve 4 completely radially. The reciprocating piston 8 is designed as an annular piston for executing the stroke and the return stroke in the hydraulic chamber 7. The annular hydraulic hammer 7 and the annular piston are arranged concentrically with the brake disc 5. They are completely held in the receiving space of the brake disc 5.

The transfer apparatus 9 is designed as a metal disc and, as can be seen from FIGS. 4 and 5, is arranged concentrically with the brake disc 5. The transfer apparatus 9 is axially movable along the wheel axle 55 (FIG. 2). It is completely held in the receiving space of the brake disc 5. In the receiving space, the transfer apparatus 9 is arranged in the same direction as the disc surface 11 of the brake disc 5.

The transfer apparatus 9 is operatively connected to the brake disc 5. For this purpose, the transfer apparatus 9 is screwed to the brake disc 5 by means of a plurality of screws 14, e.g. three screws. The transfer apparatus 9 and the brake disc 5 are therefore axially movable together, in particular displaceable along the wheel axle 55 towards the wheel rim 56.

As can be seen from FIG. 4, the transfer apparatus 9 is in an operative connection with the reciprocating piston 8 when the latter executes the stroke in the hydraulic chamber 7. When it executes the stroke, the reciprocating piston 8 presses against the transfer apparatus 9 so that it is axially displaced. In particular, the reciprocating piston 8 transfers the kinematic energy to the transfer apparatus 9.

Since the transfer apparatus 9 is operatively connected to the brake disc 5, the transfer apparatus 9 transfers kinematic energy to the brake disc 5 so that both are axially displaced together to the wheel rim of the wheel 51 and the brake disc 5 is thereby activated to brake the rotating wheel 51.

The activated brake disc 5 rests against the wheel rim 56 and/or is pressed against it in order to brake the rotating wheel 51 by means of the friction between the wheel rim 56 and the brake disc 5. In a possible exemplary embodiment, not shown, the brake disc 5 can rest directly against the wheel rim 56, for example with the circumferential edge 12, in order to brake the rotating wheel 51.

In a preferred exemplary embodiment according to FIGS. 4 and 5, the brake device 1 comprises a friction plate 15 for contact with the wheel rim 56. The friction plate 15 is designed as a friction ring made of a steel alloy. The friction plate 15 is arranged concentrically with the brake disc 5 and with the transfer apparatus 9 and is fastened to the edge 12 of the brake disc 5 so that the receiving space of the brake disc 5 is partially covered by the friction plate 15. The friction plate 15 is crimped to the edge 12, wherein the edge 12 engages around an outer edge of the friction plate 15 in a form-fitting manner. If the friction plate 15 is provided and/or is connected to the edge 12 of the brake disc 5, it is advantageous if the housing 2 and/or the brake disc 5 is/are formed from the aluminum alloy in order to ensure a secure attachment.

When the brake disc 5 is activated, the friction plate 15 forms a contact side of the brake disc 5, which rests against the wheel rim and/or is pressed against it in order to brake the rotating wheel 51 by means of friction. The friction plate 15 can advantageously reduce wear on the brake disc 5 when the rotating wheel 51 is braked.

To release the activated brake disc 5, the brake device 1 comprises at least one leaf spring 16, for example three leaf springs 16. The leaf springs 16 are riveted to the axle sleeve 4. The leaf springs 16 are arranged with respect to one another in such a way that they form a ring which radially surrounds the central recess 3 in the housing 2 and/or the axle sleeve 4. In particular, the leaf springs 16 are designed together as a multiple interrupted spring ring, wherein the leaf springs 16 form annular sections of the spring ring. The leaf springs 16 are held in the receiving space of the brake disc 5 and are arranged concentrically with the brake disc 5 and/or with the transfer apparatus 9.

The brake disc 5 is elastically mounted on the leaf springs 16. When the actuating device 57 (FIG. 1) is no longer actuated, the reciprocating piston 8 executes the return stroke so that the transfer apparatus 9 is no longer axially displaced by the reciprocating piston 8 and the brake disc 5 is no longer pressed against the wheel rim as a result. Due to the elastic mounting on the leaf springs 16, the brake disc 5 is released from the wheel rim and, together with the transfer apparatus 9, is moved back axially along the wheel axle 55 (FIG. 2) into its initial position. As a result, the brake disc 5 is deactivated and the rotating wheel 51 is no longer braked.

As can be seen from FIGS. 3 and 4, the brake device 1 comprises a torque support 17, which is designed to absorb a differential torque between the input and output of the rotating wheel 51. The torque support 17 is arranged on the axle sleeve 4 and protrudes axially therefrom so that it is supported on the wheel fork 54 (FIG. 2) and can introduce the differential torque into it.

Looking at all of FIGS. 1 to 5 together, it can be seen that the integration of the brake disc 5 into the housing 2 makes it possible to design the brake device 1 with fewer components and in a space-saving manner. Since the transfer apparatus 9, the leaf springs 16, the hydraulic chamber 7 and the annular piston are completely held in the receiving space of the brake disc 5, it is possible to design the brake device 1 to be particularly narrow and to position it next to the wheel 51 on the wheel axle 55.

### LIST OF REFERENCE NUMBERS

1 Brake device
2 Housing
3 Recess
4 Axle sleeve
5 Brake disc
6 Hydraulic device
7 Hydraulic chamber
8 Reciprocating piston
9 Transfer apparatus
10 Sealing valve
11 Disc surface
12 Edge
13 Flow channel
14 Screws
15 Friction plate
16 Leaf springs
17 Torque support
50 Vehicle
51 Front wheel
52 Rear wheel
53 Vehicle frame
54 Wheel fork
55 Wheel axle
56 Wheel rim
57 Actuating device
58 Tire

1. A brake device for a vehicle having at least one wheel, the brake device comprising:
a housing for positioning on a wheel axle of the vehicle,
a brake disc for introducing braking power into a wheel rim of the wheel, and
a transfer apparatus for transferring the braking power to the brake disc, wherein the transfer apparatus is held in the housing and is operatively connected to the brake disc,
wherein the brake disc is formed integrally with the housing.

2. The brake device according to claim 1, wherein the brake disc has an annular surface and a circumferential edge protruding axially from the annular surface, wherein the edge encloses a receiving space with the annular surface.

3. The brake device according to claim 2, wherein the transfer apparatus is designed as a disc, wherein the disc is held in the receiving space concentrically to the brake disc.

4. The brake device according to claim 2, wherein the brake device comprises a hydraulic device for generating the braking power, wherein the hydraulic device is integrated concentrically to the brake disc or to the transfer apparatus in the receiving space.

5. The brake device according to claim 4, wherein the hydraulic device comprises a hydraulically operable annular piston for activating the brake disc by executing a lifting movement against the transfer apparatus.

6. The brake device according to claim 5, wherein the brake device comprises at least one leaf spring for releasing the activated brake disc, wherein the brake disc or the transfer apparatus is elastically mounted on the at least one leaf spring.

7. The brake device according to claim 6, wherein the brake device comprises a plurality of leaf springs which complement each other to form a spring ring, wherein the spring ring is arranged concentrically with the brake disc or with the transfer apparatus.

8. The brake device according to claim 1, wherein the brake device comprises an axle sleeve, wherein the axle sleeve is arranged in a central recess in the housing and wherein the axle sleeve comprises a torque support for support on a wheel fork of the vehicle.

9. A vehicle having at least one wheel and having the brake device according to claim 1.

10. A method for braking a rotating wheel of a vehicle having the brake device according to claim 1, comprises moving the transfer apparatus axially together with the brake disc onto the wheel of the vehicle so that the brake disc is placed on a wheel rim of the wheel or pressed onto it and the rotating wheel is braked as a result.
